(19) United States
(12) Patent Application Publication
(10) Pub. No.: US 2017/0224035 A1
(43) Pub. Date: Aug. 10, 2017

(54) PROTECTIVE SUIT

(71) Applicant: VIKING LIFE-SAVING EQUIPMENT A/S, Esbjerg (DK)

(72) Inventors: Camilla CALLESEN, Vorbasse (DK); Pia LUMBYE, Esbjerg (DK); Dorthe TØRNGREN LA COUR, Kolding (DK)

(21) Appl. No.: 15/503,148

(22) PCT Filed: Aug. 11, 2015
(86) PCT No.: PCT/EP2015/068448

§ 371 Date: Feb. 10, 2017

(30) Foreign Application Priority Data
Aug. 12, 2014 (EP) 14180699.2

(51) Int. Cl. A41D 31/00; A62B 17/00; A41D 27/04

(52) U.S. Cl. CPC A41D 31/0027; A41D 27/04; A62B 17/003; A62B 17/006; A62B 17/001

(57) ABSTRACT

The present invention relates to a protective suit (1) being CE approved according to European Norm Standards EN 469:2005/A1:2006 or according to US National Fire Protection Association Standard NFPA 1971 Edition 2013 to be worn by a wearer during firefighting or similar operations, comprising a first outer fabric layer (3) which is at least made of flame-resistant material, a second basic layer (10) having a moisture barrier, and a third layer being heat-resistant, the second basic layer (10) and the third layer being connected, wherein the protective suit (1) is fulfilling EN 469:2005/A1:2006 or NFPA 1971 Edition 2013 when the first outer fabric layer (3), the second basic layer (10) and the third layer are worn together, and wherein the first outer fabric layer (3) is detachably connected with the second basic layer (10) by means of connection means (11), the connection means being arranged accessible from the outside of the protective suit, so that the wearer can easily separate the first outer fabric layer (3) from the second basic layer (10), when the first outer fabric layer has been contaminated during firefighting, without having to take off the second basic layer so that the wearer is still protected against the weather conditions. The present invention also relates to a protective suit system and a method.

### FIELD OF THE INVENTION

The present invention relates to a protective suit being CE approved according to European Norm Standards EN 469:2005/A1:2006 or according to US National Fire Protection Association Standard NFPA 1971 Edition 2013 to be worn by a wearer during firefighting or similar operations. The present invention also relates to a protective suit system and a method.

### BACKGROUND ART

Studies and research from the International Agency for Research on Cancer (IARC) show that the mortality among firefighters is higher than among the average population. The studies furthermore show that firefighters are more frequently struck by different types of cancer.

Firefighters are obviously exposed to many different hazards, such as smoke, soot, flames, chemicals, etc. during their work, and they and their protective suits will consequently be contaminated with these hazards.

Protective suits having several separate layers are known, such as those disclosed in DE202010016117U1 and U.S. Pat. No. 5,933,865A.

### SUMMARY OF THE INVENTION

It is an object of the present invention to wholly or partly overcome the above disadvantages and drawbacks of the prior art. More specifically, it is an object to provide an improved protective suit facilitating that a wearer is less exposed to contamination.

It is furthermore an object of the present invention to provide a protective suit which is easy to handle during and after use.

Moreover, it is an object to provide a protective suit which is less resource-demanding during cleaning and washing.

The above objects, together with numerous other objects, advantages and features, which will become evident from the below description, are accomplished by a solution in accordance with the present invention by a protective suit being CE approved according to European Norm Standards EN 469:2005/A1:2006 or according to US National Fire Protection Association Standard NFPA 1971 Edition 2013 to be worn by a wearer during firefighting or similar operations, comprising:
a first outer fabric layer which is at least made of a flame-resistant material,
a second basic layer having a moisture barrier, and
a third layer being heat-resistant, the second basic layer and the third layer being connected,
   wherein the protective suit fulfils EN 469:2005/A1:2006 or NFPA 1971 Edition 2013 when the first outer fabric layer, the second basic layer and the third layer are worn together, and
   wherein the first outer fabric layer is detachably connected with the second basic layer by means of connection means, the connection means being arranged accessible from the outside of the protective suit, so that the wearer can easily separate the first outer fabric layer from the second basic layer, when the first outer fabric layer has been contaminated during firefighting, without having to take off the second basic layer, so that the wearer is still protected against the weather conditions.

Hereby, a protective suit is obtained where the contaminated outer layer may easily be removed from the rest of the protective suit without the wearer having to undress completely. Thus, since the wearer may remove the outer contaminated layer, the period of time during which the wearer or others and the environment may be exposed to contamination is reduced considerably.

Furthermore, the protective suit is designed so that after the wearer has removed the outer layer, he or she will still be fully dressed and protected against moisture, cold and awkward situations in which he or she would otherwise have had to undress in public areas.

In addition, when the protective suit is to be washed and cleaned, it is possible to only wash the outer layer, since this layer is the contaminated layer. Hereby, the resources spent on washing the protective suit will be reduced to approximately a third of what is spent on washing known protective suits. An additional advantage is that the lifespan of the protective suit according to the present invention has been prolonged due to the reduced subjection to deterioration of the protective suit during wash.

Moreover, the connection means may be zippers, press buttons, hook and loop or the like.

Additionally, the connection means may be zippers, each zipper may comprise a slider, the slider having a grip part enabling the wearer to slide the slider along the zipper to open and close the zipper, and the grip part being arranged so that it faces outwards in relation an outside face of the protective suit, whereby the grip part of the slider is accessible from the outside.

Also, the second basic layer may be made without the moisture barrier.

Furthermore, the protective suit may comprise a jacket, and the second basic layer may comprise a first zipper adapted to close and open the jacket, on opposite sides of the first zipper, the first outer fabric layer being connected with the second basic layer via a second zipper and a third zipper, the second zipper and third zipper extending along the first zipper on opposite sides of the first zipper.

The second zipper and the third zipper may have sliders with grip parts being accessible from the outside without the first zipper being open.

In addition, the first outer fabric layer may comprise a front flap adapted to overlap the first, second and third zippers for protecting these during firefighting.

The jacket may comprise a detachable hood, the hood being attached to the jacket by zippers, press buttons, hook and loop or the like.

The protective suit may also comprise trousers having a top area, wherein a fourth zipper extends around the top area, whereby the first outer fabric layer from the fourth zipper can be detached from the second basic layer.

Moreover, the protective suit may further comprise a lining, the lining being arranged in connection with the second basic layer and the third layer.

Also, the liner may be securely attached to the second basic layer.

Furthermore, an opening may be arranged between the second basic layer and the third layer and the lining, the opening being closable by means of an inspection zipper.

In addition, the first outer fabric layer and/or the second basic layer may be made of a fabric making the layers water-proof.

The protective suit may also comprise a membrane being water-proof. Moreover, the protective suit may be impregnated to provide waterproofness to the protective suit.

Additionally, the first outer fabric layer may comprise fibres made of aramid.

Moreover, the first outer fabric layer and the second basic layer may be breathable.

Furthermore, the first outer fabric layer may comprise reflective a trim. The reflective trim may comprise a first strip made of a breathable fabric and a plurality of reflective strips which are spaced apart on the first strip so that the first strip maintains its breathability between the reflective strips.

The protective suit may also have one or more outer face(s), and at least one of the outer faces may comprise at least one attachment facility, said attachment facility comprising a webbing made of a flame-resistant material, the webbing having a length and extending substantially in a horizontal direction and/or vertical direction of the outer faces, the webbing being securely fixed to the outer faces by a plurality of substantially vertical connections for the horizontally extending webbings and horizontal connections for the vertical extending webbings, the connections being arranged along the length of the webbing with a mutual distance between them so that two adjacent connections form a space between them, the outer faces and the webbing.

Moreover, a plurality of attachment facilities may be arranged on the outer faces.

Additionally, a plurality of attachment facilities may be arranged in a group.

The protective suit according to the present invention may further comprise one or more pockets having one or more fastening part(s) adapted to be inserted into one or more of the spaces.

Moreover, the protective suit according to the present invention may further comprise one or more holders for equipment, the holders having one or more fastening part(s) adapted to be inserted into one or more of the spaces.

Furthermore, the pockets and holders may comprise corresponding attachment facilities on their inner faces facing the outer faces of the protective suit, and at least two straps, the straps having one end which is connected to the inner face of the pocket or holder, whereby the straps can first be weaved into an attachment facility on the outer face, second into an attachment facility on the inner face of the pocket or holder, and third into an attachment facility on the outer face and so on, until the pocket or holder is securely fastened to the attachment facilities of the outer surface.

The invention also relates to a protective suit system to be worn by a wearer during firefighting or similar operations, comprising the protective suit as mentioned above, wherein the protective suit comprises a plurality of first outer fabric layers.

When the contaminated outer layer has been removed, a new outer layer may easily be remounted outside the basic layer, so that the protective suit is ready for use again.

The protective suit system may further comprise one or more storage bag(s) for storing the first outer fabric layer when removed from the second basic layer.

When the outer layer has been contaminated during firefighting or other operations, the wearer may easily place the contaminated outer layer in the storage bag, so that the contamination is isolated to the storage bag. The exposure to the contamination inflicted on the wearer and his/her surroundings is then minimised. The storage bag may be a washing bag.

The present invention also relates to a method for handling a protective suit as described above after a wearer has worn it during firefighting or other operations, the method comprising the steps of:
providing access to the connection means,
separating the contaminated first outer fabric layer from the second basic layer by opening the connection means, and
removing the first outer fabric layer from the second basic layer while the wearer keeps the second basic layer on.

The method may further comprise the step of placing the contaminated first outer fabric layer in a storage bag so that the first outer fabric layer will not contaminate the wearer or the surrounding environment.

Furthermore, the method may comprise the steps of:
positioning a new uncontaminated first outer fabric layer onto the second basic layer while the wearer is wearing the second basic layer, and
connecting the first outer fabric layer with the second basic layer by means of the accessible connection means.

### BRIEF DESCRIPTION OF THE DRAWINGS

The invention and its many advantages will be described in more detail below with reference to the accompanying schematic drawings, which for the purpose of illustration show some non-limiting embodiments and in which

FIGS. 1-3 show a jacket of the protective suit according to the present invention,

FIG. 4 shows the second basic layer,

FIG. 5 shows an attachable hood which may be attached to the jacket, and

FIGS. 6-7 show a pair of trousers of the protective suit according to the present invention.

All the figures are highly schematic and not necessarily to scale, and they show only those parts which are necessary in order to elucidate the invention, other parts being omitted or merely suggested.

### DETAILED DESCRIPTION OF THE INVENTION

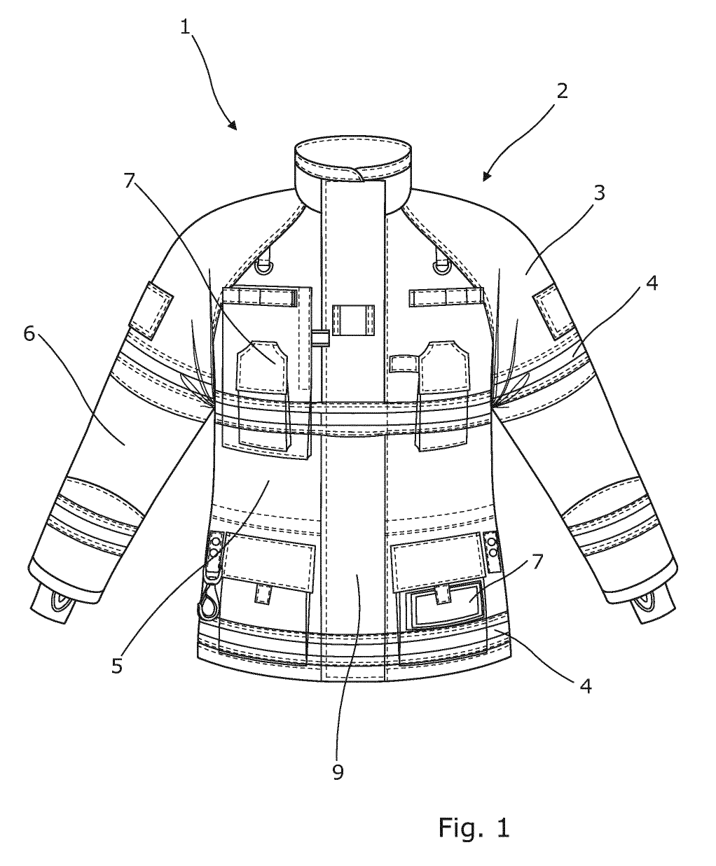

FIG. 1 shows a jacket 2 of the protective suit 1 according to the present invention. In FIG. 1, the jacket 2 is shown from a front side.

The protective suit 1 is CE approved according to European Norm Standards EN 469:2005/A1:2006 or according to US National Fire Protection Association Standard NFPA 1971 Edition 2013 so that the protective suit 1 provides full protection against heat, flames, water and chemicals. This is obtained by incorporating different layers in the protective suit 1, each having different properties so that when worn together, all layers in the protective suit provide the intended protection.

The protective suit 1 has a first outer fabric layer 3 which is at least made of a flame-resistant material, a second basic layer (not shown in FIG. 1) having a moisture barrier, and a third layer being heat-resistant, the second basic layer and the third layer being connected. The second basic layer is arranged inside the first outer fabric layer 3. In another embodiment, the second basic layer may be made without the moisture barrier.

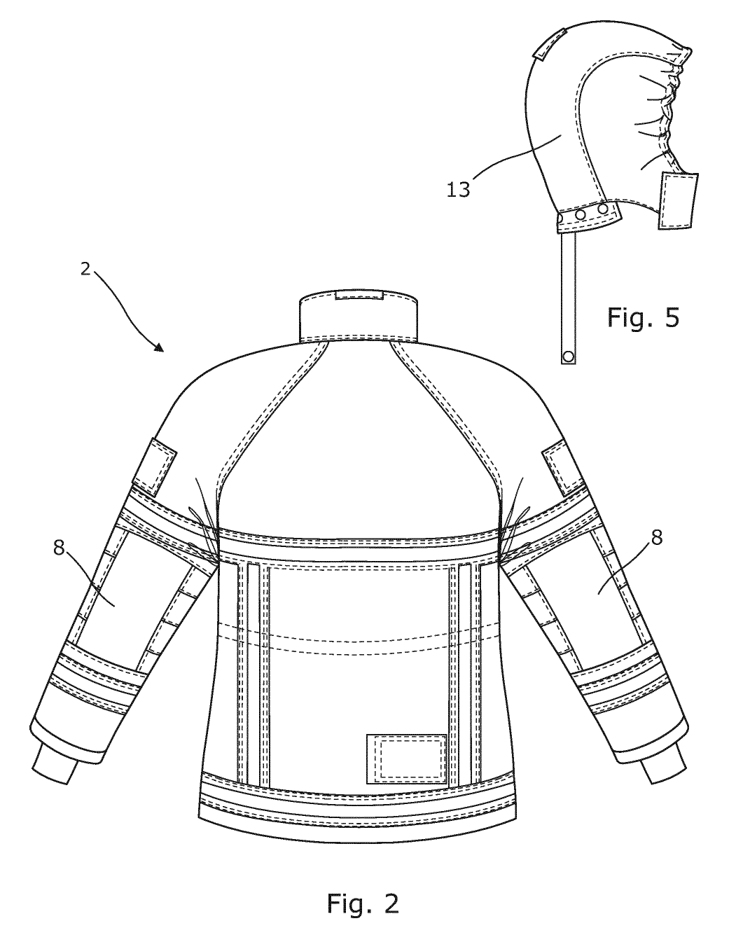

The jacket 2 furthermore comprises a reflective trim 4 arranged around the jacket, both on the body part 5 and the arms 6. Moreover, the jacket comprises several pockets 7 accessible from the outside. These pockets may be reinforced with Kevlar twill in their lower parts. The jacket 1 may obviously comprise additional features, such as detachable snap hook straps, brass and reinforced elbow areas 8, as seen on FIG. 2 in which the jacket 2 is shown from the back.

The jacket 2 also comprises a long front flap 9 arranged to overlap and protect the closing means of the jacket 2.

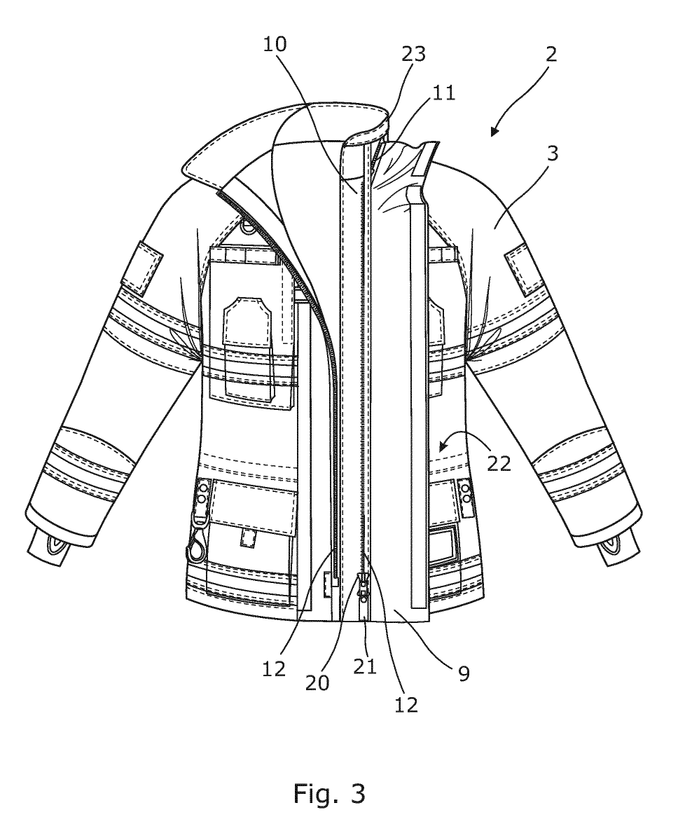

In FIG. 3, the jacket 2 is shown partly open, the front flap being open so that access to the closing means of the jacket 2 is provided.

According to the invention, the first outer fabric layer 3 is detachably connected with the second basic layer 10 by means of connection means 11, the connection means 11 being arranged accessible from the outside of the protective suit, so that the wearer can easily separate the first outer fabric layer 3 from the second basic layer 10, when the first outer fabric layer 3 has been contaminated during firefighting, without having to take off the second basic layer 10. In this regard, it is important that access to the connection means 11 is provided without the wearer having to take off the protective suit 1, so that the first outer layer 3 can be detached from the second basic layer 2 while the wearer is still wearing the second basic layer.

The connection means 11 may be zippers, press buttons, hook and loop or the like. In the shown embodiment, the connection means 11 are zippers 11. The second basic layer 10 comprises a first zipper 12 adapted to close and open the jacket 2, on opposite sides of the first zipper 12, the first outer fabric layer 3 being connected with the second basic layer 10 via a second zipper 11 and a third zipper 11, the second zipper 11 and third zipper 11 extending along the first zipper 12 on opposite sides of the first zipper 12. Hereby it is obtained that the wearer may easily get access to the connection means and thereby, in a normal manner, separate the first outer layer 3 from the second basic layer 10 without opening the second basic layer 10, as mentioned above.

In addition, each zipper comprises a slider 20, the slider 20 having a grip part 21 enabling the wearer to slide the slider 20 along the zipper to open and close the zipper. The grip part 21 is arranged so that it faces outwards in relation an outside face 22 of the protective suit, whereby the grip part 21 of the slider 20 is accessible from the outside. Again, this facilitates that the wearer can detach the first outer layer from the second basic layer without having to undress, whereby the wearer will still have some protection.

Furthermore, the jacket 2 may comprise a collar 23.

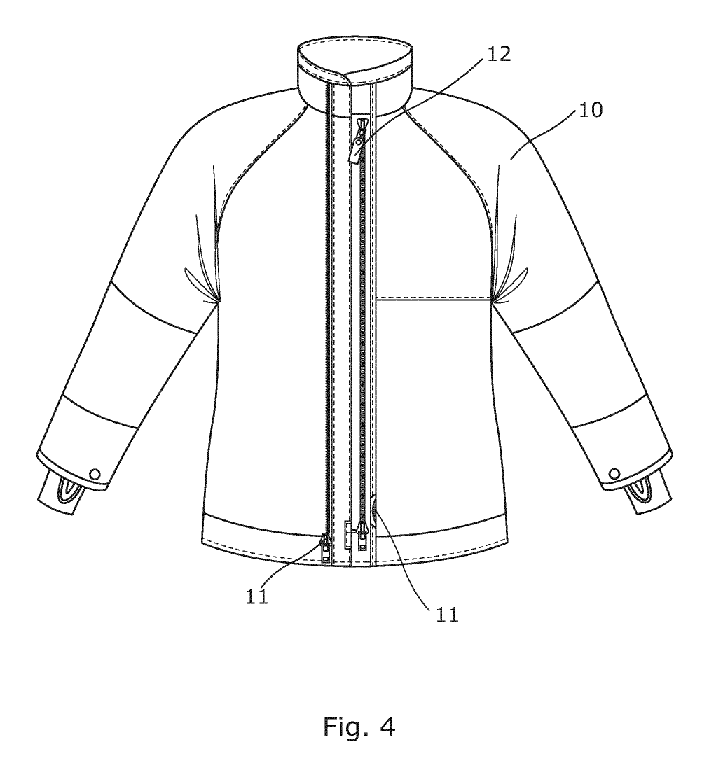

In FIG. 4, the second basic layer 10 is shown, wherein it may be used as a jacket still providing comfort and protection to the wearer, while the contaminated outer fabric layer 3 is removed. A third layer (not shown) is connected with the second basic layer. The second basic layer 10 shown in FIG. 4 has the first zipper 12 with the second and third zippers 11 arranged on opposite sides of the first zipper 12. From FIG. 4, it is easily deduced that the second and third zippers 11 may be handled, i.e. opened and closed, without opening the second zipper 12.

The protective suit 1 may also comprise a detachable hood 13, as shown in FIG. 5. The hood 13 may be attached to the jacket by zippers, press buttons, hook and loop or the like.

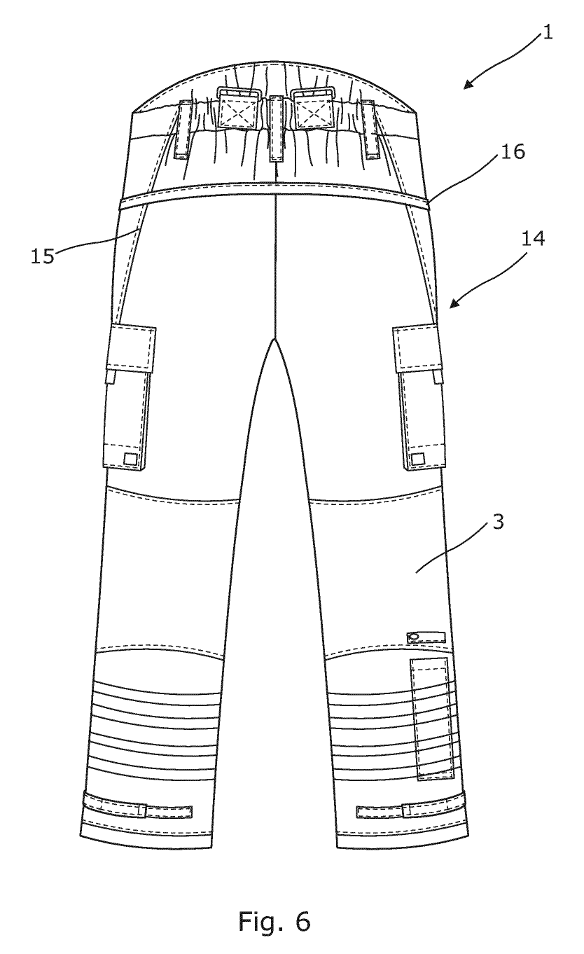

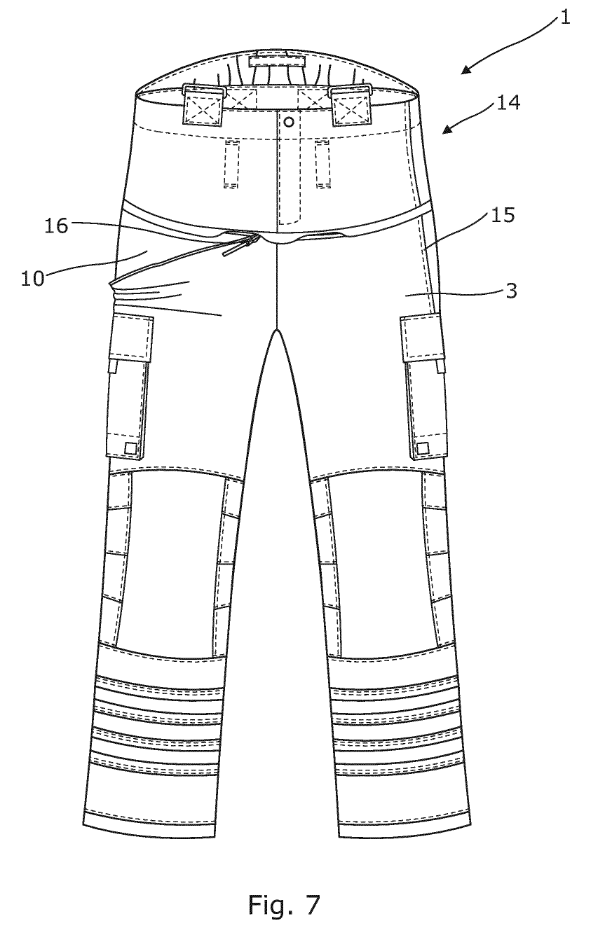

In FIGS. 6-7, trousers 14 of the protective suit 1 are shown, the trousers being intended to be used in connection with the jacket 2 shown in FIGS. 1-4. FIG. 6 shows the trousers 14 seen from the back, and FIG. 7 shows the trousers seen from the front.

The trousers 14 have a top area 15 wherein a fourth zipper 16 extends around the top area 15, whereby the first outer fabric layer 3 from the fourth zipper 16 and downwards can be detached from the second basic layer 10. As described above, this makes it possible for the wearer to separate the first outer fabric layer 3 of the trousers 14, when it has been contaminated, without having to take off the second basic layer 10. The fourth zipper may extend around the hip or waist areas of the trousers.

Furthermore, the protective suit 1 may also comprise a lining (not shown), the lining being arranged in connection with the second basic layer and the third layer (not shown). The liner may be securely attached to the third layer which in turn may be securely connected with the second basic layer, for instance by means of sewing, or it may be detachable connected. In addition, an opening (not shown) may be arranged between the second basic layer/third layer and the lining, the opening being closable by means of an inspection zipper so that the protective suit may be inspected between the liner and the layers.

The protective suit 1 may have different properties incorporated, for instance the first outer fabric layer and/or the second basic layer may be water-proof, and they may be breathable.

The invention also relates to a protective suit system to be worn by a wearer during firefighting or similar operations, comprising the protective suit according to any of the preceding claims, wherein the protective suit comprises a plurality of first outer fabric layers. Hereby it is obtained that the first outer layer may easily be removed when contaminated and exchanged by a new uncontaminated first outer fabric layer, so that the protective suit fulfils the requirements according to Norm EN469 or NFPA 1971 Edition 2013.

The protective suit system may further comprise one or more storage bag(s) for storing the first outer fabric layer when removed from the second basic layer so that the storage bag isolates the contamination of the first outer fabric layer. Hereby it is obtained that the wearer and his/her surroundings are not contaminated by the contaminated outer layer as in the known solutions.

The present invention also relates to a method for handling a protective suit 1 as described above after a wearer has worn it during firefighting or other operations. The method comprises the steps of:
providing access to the connection means 11,
separating the contaminated first outer fabric layer 3 from the second basic layer 10 by opening the connection means 11, and
removing the first outer fabric layer 3 from the second basic layer while the wearer keeps the second basic layer 10 on.

Hereinafter, the contaminated first outer fabric layer 3 may be placed in a storage bag so that the first outer fabric layer will not contaminate the wearer or the surrounding environment.

The method may further comprise the steps of:
positioning a new uncontaminated first outer fabric layer onto the second basic layer while the wearer is wearing the second basic layer, and
connecting the first outer fabric layer with the second basic layer by means of the accessible connection means.

Although the invention has been described in the above in connection with preferred embodiments of the invention, it will be evident for a person skilled in the art that several modifications are conceivable without departing from the invention as defined by the following claims.

1-15. (canceled)

16. A downhole valve system for controlling a flow of a fluid to and from a formation, comprising:
a casing having an inner surface, an outer diameter and an inner diameter, and a cross section defined by the inner diameter, the casing comprising:
a plurality of valves arranged spaced apart from each other for controlling the flow of the fluid to and from the formation through the casing, and
a plurality of autonomous operating adjusting devices each controlling one of the plurality of valves and each autonomous operating adjusting device comprising a body having an outer body diameter and a body cross section, the plurality of autonomous operating adjusting devices being fastened inside the casing in order to allow the fluid to flow between the outer body diameter of the body of the autonomous operating adjusting device and the casing.

17. A downhole valve system according to claim 16, wherein the cross section of the body of the autonomous operating adjusting device is less than 50% of the cross section of the casing defined by the inner diameter, preferably less than 40%, and more preferably less than 30%.

18. A downhole valve system according to claim 16, wherein the body of the autonomous operating adjusting device is arranged concentrically with the casing.

19. A downhole valve system according claim 16, wherein the body of the autonomous operating adjusting device abuts the inner surface of the casing.

20. A downhole valve system according to claim 16, wherein the system comprises a sensor for measuring a condition of the fluid, such as the temperature, pressure, water out, density or flow rate.

21. A downhole valve system according to claim 20, wherein a sensor is arranged in each autonomous operating adjusting device.

22. A downhole valve system according to claim 20, wherein each autonomous operating adjusting device comprises a processor for computing measured sensor data for controlling the valve.

23. A downhole valve system according to claim 16, wherein each autonomous operating adjusting device comprises a communication means.

24. A downhole valve system according to claim 16, wherein the plurality of autonomous operating adjusting devices are positioned in succession of each other in the casing.

25. A downhole valve system according to claim 16, wherein each autonomous operating adjusting device comprises a dispatching means for dispatching an information device.

26. A downhole valve system according to claim 16, wherein each autonomous operating adjusting device comprises a pressure pulse communication means for receiving signals from surface and/or another autonomous operating adjusting device.

27. A downhole valve system according to claim 16, wherein each valve comprises a displaceable part for adjusting the inflow of fluid.

28. Method for controlling a flow of fluid by controlling a plurality of valves in a downhole valve system according to claim 16, the method comprising:
arranging each autonomous operating adjusting device opposite one of the valves,
fastening the autonomous operating adjusting device to the inner surface of the casing,
measuring a condition of the fluid, and
controlling the valve based on the measured condition of the fluid.

29. Method for controlling an flow of fluid according to claim 28, wherein arranging each autonomous operating adjusting device is performed by a deployment means, such as a wireline or a downhole driving unit, and wherein the method further comprises releasing the autonomous operating adjusting device from the deployment means.

30. Method for controlling a flow of fluid according to claim 28, wherein the method further comprises adjusting a position of the displaceable part of the valve.
